(19) United States
(12) Patent Application Publication
(10) Pub. No.: US 2017/0113308 A1
(43) Pub. Date: Apr. 27, 2017

(54) ALIGNMENT RECTIFYING DEVICE

(71) Applicant: Shawn Major, Baton Rouge, LA (US)

(72) Inventor: Shawn Major, Baton Rouge, LA (US)

(21) Appl. No.: 14/924,016

(22) Filed: Oct. 27, 2015

(51) Int. Cl. B23K 37/053; F16L 9/02; F16L 13/02

(52) U.S. Cl. CPC B23K 37/0531; F16L 13/02; F16L 9/02

(57) ABSTRACT

An alignment rectifying device for a rectifying a joint between two joint between two pipes includes a central hub, multiple plunger-cylinder assemblies, and a curved plate member. Each plunger-cylinder assembly comprises a plunger portion in sliding communication within a cylinder portion, where each plunger-cylinder assembly outspreads radially from the central hub, each plunger-cylinder assembly actuated by a hydraulic pump positioned within the hub to radially extend the plunger portion of the plunger-cylinder assembly. The curved plate member is positioned at the distal end of the plunger portion each plunger-cylinder assembly, where the curved plate member is configured to contact a surface of joint between two pipes internally, where each curved plate member actuated by the hydraulic pump applies pressure on the joint to rectify misalignment at the joint.

### BACKGROUND

During the process of laying a pipe line, for example, an oil pipeline, it is normally essential to weld a sector of pipe to an end of the pipeline. The pipeline may be aligned and laid under a water body such as sea. The welded joints between consecutive units of pipe characteristically need to be of superior quality and reliability, because underwater pipelines are characteristically exposed to cyclic loading both during and after the installation or commissioning process, giving an increased risk of failing of the joints because of the fatigue loading during the aforementioned cycle. Misalignment of the ends of pipes during the welding process of a joint can adversely affect the quality of the weld generated. The precise welding of two pipe ends is therefore of primary importance. Subsequently, it is necessary to measure the amount of misalignment before and/or after the welding process.

Such misalignment, or Hi-Lo as generally known in piping industry, is a common problem caused by human error, carelessness, or due to joining pipes of different thickness. Increased levels of high-low misalignment in pipeline girth welds have been identified as one of the contributing factors to hydrostatic test failures or pipeline service failures. Conventionally, the primary solution involves grinding the area or slowing down production time by paying meticulous attention to detail. The welding industry has several tools designed to detect Hi-Lo or misalignment; however, the existing solutions has not been proactive in preventing Hi-Lo, until now.

Hence, there is a long felt but unresolved need for an alignment rectifying device for pipes which corrects the bends at pipe ends, thereby enabling a precise and rigidly welded joint between two pipes.

### SUMMARY OF THE INVENTION

The alignment rectifying device for rectifying a joint between two pipes comprises a central hub, multiple plunger-cylinder assemblies, and a curved plate member. Each plunger-cylinder assembly comprises a plunger portion in sliding communication within a cylinder portion, where each plunger-cylinder assembly outspreads radially from the central hub, each plunger-cylinder assembly actuated by a hydraulic pump positioned within the hub to radially extend the plunger portion of the plunger-cylinder assembly. In an example, each cylinder haves a cut off that can make each cylinder work by itself. The curved plate member is positioned at a distal end of the plunger portion of each plunger-cylinder assembly, where the curved plate member is configured to contact a surface of joint between two pipes internally, where each curved plate member actuated by the hydraulic pump applies pressure on the joint to rectify misalignment at the joint.

In an embodiment, where the cylinder portion comprises a hollow barrel and a hollow middle cylinder. The hollow barrel extends from the central hub configured to allow transmission of a working fluid pumped from the hydraulic pump; and the hollow middle cylinder extends from above the hollow barrel, where the hollow middle cylinder is configured to receive and transmit the pumped working fluid from the hollow barrel to make contact with the plunger portion removably attached above the hollow middle cylinder. In an embodiment, the plunger portion is configured as a plunger rod, where the curved plate member is fixedly attached at a distal end of the plunger rod.

In an embodiment, the alignment rectifying device further comprises a door positioned outside of the central hub which allows access to the inside of the central hub for repair and maintenance. In an embodiment, where the hydraulic pump comprises an inbuilt fluid container or an external fluid container. In an embodiment, the alignment rectifying device further comprises a pump connector valve configured as a connector between hydraulic pump and the tool, and the pump connector valve comprise of different sizes and shapes. In an embodiment, the alignment rectifying device further comprises a bleeder valve removably attached with the central hub of the alignment rectifying device which is configured to be in communication with the hydraulic pump to bleed excess air accumulated in the working fluid passage. In an embodiment, the alignment rectifying device further comprises a spring member fixedly attached between the central hub and the curved plate member to provide extension and retraction to the plunger portion, thereby adjusting the position of the plunger portion during rectification of the misalignment in the joint between two pipes.

### BRIEF DESCRIPTION OF THE DRAWINGS

FIG. 1 exemplarily illustrates a front perspective view of the alignment rectifying device.

FIG. 2 exemplarily illustrates an exploded view of the alignment rectifying device.

FIG. 3A exemplarily illustrates a rear perspective view of the alignment rectifying device.

FIG. 3B exemplarily illustrates a rear perspective view of the central hub of the alignment rectifying device as shown in FIG. 3A.

### DETAILED DESCRIPTION OF THE INVENTION

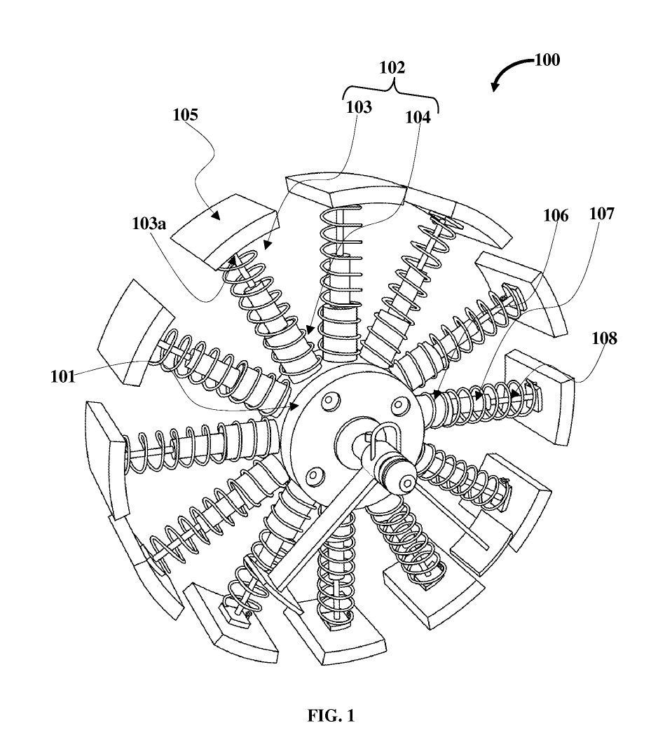

FIG. 1 exemplarily illustrates a front perspective view of the alignment rectifying device 100. The alignment rectifying device 100 for rectifying a joint between two pipes comprises a central hub 101, multiple plunger-cylinder assemblies 102, and a curved plate member 105. Each plunger-cylinder assembly 102 comprises a plunger portion 103 in sliding communication within a cylinder portion 104, where each plunger-cylinder assembly 102 outspreads radially from the central hub 101, each plunger-cylinder assembly 102 actuated by a hydraulic pump positioned within the central hub 101 to radially extend the plunger portion 103 of the plunger-cylinder assembly 102. The curved plate member 105 is positioned at the distal end 103a of the plunger portion 103 each plunger-cylinder assembly 102, where the curved plate member 105 is configured to contact a surface of joint between two pipes internally, where each curved plate member 105 actuated by the hydraulic pump applies pressure on the joint to rectify misalignment at the joint. The misalignment at the joint is popularly known as Hi-Lo. The purpose of the alignment rectifying device 100 is to eliminate Hi-Lo in pipe joints.

In an embodiment, where the cylinder portion 104 comprises a hollow barrel 106 and a hollow middle cylinder 107. The hollow barrel 106 extends from the central hub 101 configured to allow transmission of a working fluid pumped from the hydraulic pump, and the hollow middle cylinder 107 extends from above the hollow barrel 106, where the hollow middle cylinder 107 is configured to receive and transmit the pumped working fluid from the hollow barrel 106 to make contact with the plunger portion 103 removably attached above the hollow middle cylinder 107. In an embodiment, the plunger portion 103 is configured as a plunger rod 108, where the curved plate member 105 is fixedly attached at a distal end of the plunger rod 108.

The alignment rectifying device 100 is, for example, a circular hub that externally houses about 12-extendable cylinders around its perimeter. Each cylinder consists of the barrel, middle cylinder, and a plunger which is configured to extend and retract. On the end of each plunger rod 108 is a curved plate member 105, for example, a curved shaped shoe. When fully retracted or simultaneously extended, the alignment rectifying device 100 forms a perfect 360-degree wheel. In an embodiment, a door is positioned outside of the central hub 101 which allows access to the inside of the central hub 101 for repair and maintenance.

The working of the alignment rectifying device 100 involves a fitter or a mechanic placing the alignment rectifying device 100 within a first pipe in a sideways manner or parallel with the opening of the first pipe, and leaving one or more inches of the plunger portion 103 exposed. Next the fitter will slide the second pipe over the exposed end of the alignment rectifying device 100 until both pipes are close enough to begin tacking. Once the pipes are securely joined, the fitter can begin extending the plunger portions 103 to stretch out the pipes and make them perfectly even. Alternately, the fitter can tack the first and the second pipe together, then move or crawl into the pipes and place the alignment rectifying device 100 evenly at the joint of the pipes. The fitter can now stretch out the pipes until they are perfectly even. The alignment rectifying device 100 is, for example, a 360-degree wheel with the capability to extend in a full 360-degree circle simultaneously or individually, and is able to withstand the pressure and heat of different types of pipes utilized in welding, and they are created or intended for those purposes.

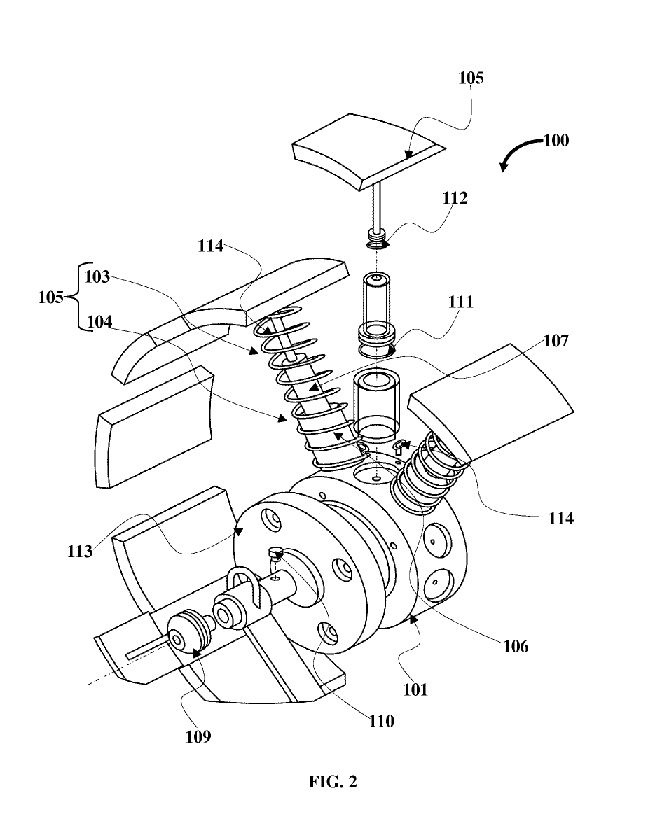

FIG. 2 exemplarily illustrates an exploded view of the alignment rectifying device 100. The alignment rectifying device 100 facilitates the pumping of the working fluid, for example, any hydraulic fluid, into the tool housing to be transferred into the central hub 101 passing through a pump connector valve 109, and then to every plunger portion 103 mounted on the central hub 101, pressurizing the plunger portions 103 to extend gradually until the setting pressure set by the hydraulic pump and monitored by pressure gauges. The parts of the alignment rectifying device 100 can be purchased from as local market as well. In an embodiment, the hydraulic pump can be both manual as well as motorized pump for pumping the working fluid. In an embodiment, the hydraulic pump can also have inbuilt fluid container, or external fluid container. In an embodiment, the pump connector valve 109 is configured as a connector between hydraulic pump and the tool. As most of the hydraulic pumps have a specialized connector therefore a suitable pump connector valve 109 is required for the manufacturing.

In an embodiment, the pump connector vale 109 comprise of different shapes and sizes and should have leak-proof attachment with the hydraulic pump. In an embodiment, a bleeder valve 110 is removably attached with the central hub 101 of the alignment rectifying device 100 and is in communication with the hydraulic pump to bleed excess air accumulated in the working fluid passage. The hole and the threads in the central hub 101 cover need to be manufactured as per the dimensions of the bleeder valve 110. There are three different types of seals used in the manufacturing, as provided in the following description. In an embodiment, a seal ring 111 for the hollow middle cylinder 107 is positioned such that the internal diameter of the seal ring 111 is configured to the diameter of a groove on the hollow middle cylinder 107. The diameter of the seal ring 111 is large enough such that the seal ring 111 press fits to the internal diameter of the hollow middle cylinder 107. In an embodiment, a seal ring 112 is provided for plunger portion 103 or the plunger rod, and is selected such that the internal diameter should touch the diameter of the plunger rod or the extender plunger groove. The diameter of the seal ring 112 is large enough such that the seal ring 112 press fits to the internal diameter of the plunger portion 103.

In an embodiment, a seal is provided for the central hub 101 and cover to make the assembly leak proof, where the grooves in the central hub 101 and the cover 113 can be changed or removed if needed as per seal which is available from the local market. Fasteners are also provided to fasten the central hub 101 and the cover 113. The hole in the central hub 101 and the cover 113 need to be made according to sizing of the fastener, and the cover 113 should not have tapping or threads for flexible movement of the fastener. Another fastener is also needed to fasten the stand with the hub cover 113. Manufacturer also need to arrange the fastener for the same and manufacture threaded hole on the stand accordingly. In an embodiment, a spring member 114, for example, a metallic coiled spring, is fixedly attached between the central hub 101 and the curved plate member 105 to provide extension and retraction to the plunger portion 103, thereby adjusting the position of the plunger portion 103 during rectifying the misalignment in the joint between two pipes. The spring member 114 is selected so that the internal diameter of the spring member 114 is equal to outer diameter of the central hub 101. In an embodiment, the spring member 114 is locked via a spring lock 115 attached with the central hub 101 at the lower end and extender foot at the upper end which is below the curved plate member 105.

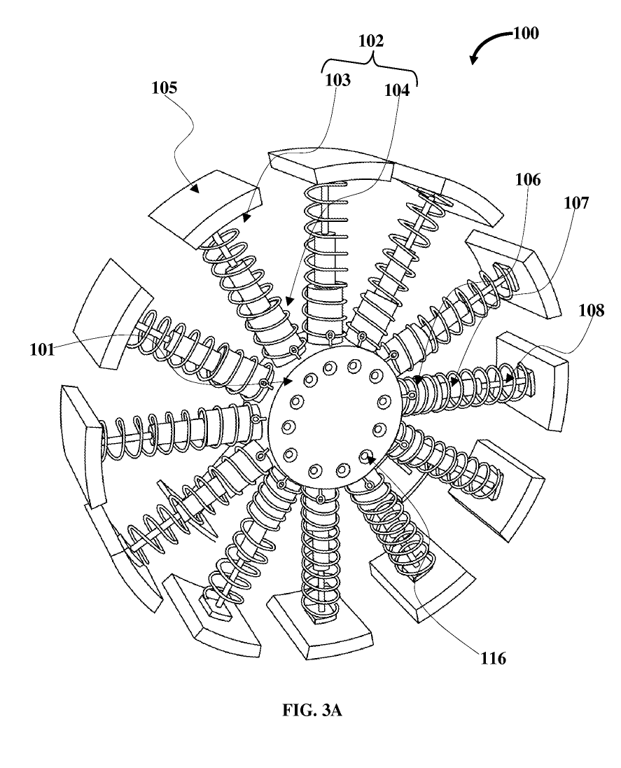

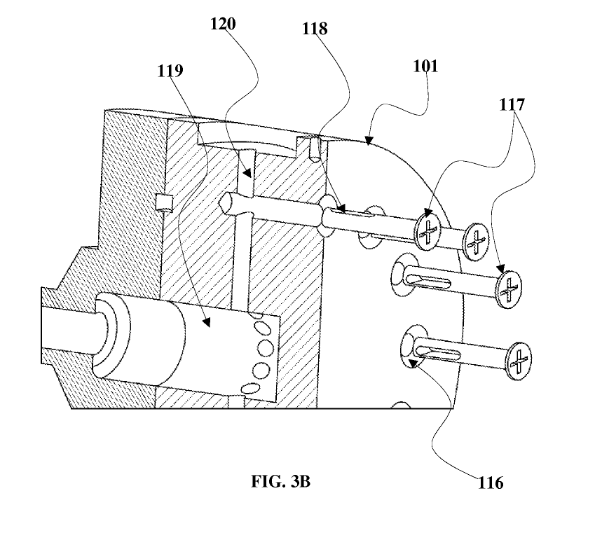

FIG. 3A exemplarily illustrates a rear perspective view of the alignment rectifying device 100, and FIG. 3B exemplarily illustrates a rear perspective view of the central hub 101 of the alignment rectifying device 100 as shown in FIG. 3A. In an embodiment, the rear portion of the central hub 101 comprises openings 116 for receiving fasteners 117, where the fasteners 117 comprise cavities 118 to allow or disallow the working fluid to be transferred from the central hub 101 to each plunger portion 103 mounted on the central hub 101, that is, the fastener 117 or the screw has a cut slot in it to control the fluid flow. The working fluid stored within the storage cavity 119 of the central hub 101, is configured to be pumped outwardly via the transfer lines 120 and to each plunger portion 103. When the fastener 117 with the cavity 118 is introduced into the opening 116, the positioning of the cavity 118 within the transfer lines 120 determines the passage of the working fluid through the transfer lines 120.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

What is claimed is:

1. A device for rectifying a joint between two pipes, the device comprising:
a central hub;
a plurality of plunger-cylinder assemblies, each plunger-cylinder assembly comprising a plunger portion in sliding communication within a cylinder portion, each plunger-cylinder assembly outspreading radially from the central hub, each plunger-cylinder assembly actuated by a hydraulic pump positioned within the central hub to radially extend the plunger portion of the plunger-cylinder assembly; and
a curved plate member positioned at the distal end of the plunger portion of each plunger-cylinder assembly, the curved plate member configured to contact a surface of joint between two pipes internally, wherein each curved plate member actuated by the hydraulic pump applies pressure on the joint to rectify misalignment at the joint.

2. The alignment rectifying device of claim 1, wherein the cylinder portion comprises:
a hollow barrel extending from the central hub configured to allow transmission of a working fluid pumped from the hydraulic pump; and
a hollow middle cylinder extending from above the hollow barrel, wherein the hollow middle cylinder is configured to receive and transmit the pumped working fluid from the hollow barrel to make contact with the plunger portion removably attached above the hollow middle cylinder.

3. The alignment rectifying device of claim 1, wherein the plunger portion is configured as a plunger rod, wherein the curved plate member is fixedly attached at a distal end of the plunger rod.

4. The alignment rectifying device of claim 1, further comprising a door is positioned outside of the central hub which allows access to the inside of the central hub for repair and maintenance.

5. The alignment rectifying device of claim 1, wherein the hydraulic pump comprises one of an inbuilt fluid container and an external fluid container.

6. The alignment rectifying device of claim 1, further comprising a pump connector valve configured as a connector between hydraulic pump and the tool, and the pump connector valve comprise of different sizes and shapes.

7. The alignment rectifying device of claim 1, further comprising a bleeder valve removably attached with the central hub of the alignment rectifying device which is configured to be in communication with the hydraulic pump to bleed excess air accumulated in the working fluid passage.

8. The alignment rectifying device of claim 1, further comprising a spring member is fixedly attached between the central hub and the curved plate member to provide extension and retraction to the plunger portion, thereby adjusting the position of the plunger portion during rectification of the misalignment in the joint between two pipes.

9. The alignment rectifying device of claim 1, wherein the rear portion of the central hub further comprises openings configured for receiving fasteners, wherein the fasteners comprise cavities to one of allow and disallow the working fluid to be transferred from the central hub to each plunger portion mounted on the central hub.
